(19) United States
(12) Patent Application Publication
(10) Pub. No.: US 2023/0257569 A1
(43) Pub. Date: Aug. 17, 2023

(54) POLYMER COMPOSITION SUITABLE FOR HIGH TEMPERATURE STERILIZATION WITH EXCELLENT HAZE PROPERTIES

(71) Applicant: W.R. Grace & Co.-Conn., Columbia, MD (US)

(72) Inventors: Jing Zhong, Columbia, MD (US); John K. Kaarto, Missouri City, TX (US); Zhiru Ma, Ellicott City, MD (US)

(73) Assignee: W.R. Grace & Co.-Conn., Columbia, MD (US)

(21) Appl. No.: 18/015,524

(22) PCT Filed: Jul. 7, 2021
(86) PCT No.: PCT/US2021/040667

§ 371 Date: Jan. 10, 2023

Related U.S. Application Data
(60) Provisional application No. 63/050,771, filed on Jul. 11, 2020.

(51) Int. Cl. C08L 23/14; C08F 210/06; C08K 5/053

(52) U.S. Cl. CPC C08L 23/142; C08F 210/06; C08K 5/053; C08F 2800/20; C08L 2205/025; C08L 2314/02; C08L 2205/24; C08L 2201/08; C08L 2203/30

(57) ABSTRACT

Propylene and butene random copolymers are disclosed that have excellent stiffness properties and excellent transparency characteristics especially when combined with one or more nucleating agents. The propylene-butene copolymers can be made with different melt flow characteristics making them well suited for use in injection molding, blow molding and thermoforming applications.

### BACKGROUND

Transparency in combination with stiffness are highly desirable properties for many polymer applications. For example, polymers can be used to produce various different products such as packaging or containers where transparency can be very beneficial to the user. In many situations, for instance, it is highly advantageous to view the contents of the packaging or the container through the walls of the packaging or the container. In addition to packaging and containers, various other molded articles, including medical devices, can benefit from some degree of transparency.

One type of polymer that can be made highly transparent are semi-crystalline polypropylene polymers. Polypropylene polymers are generally translucent due to a high crystallinity and large spherulites. The transparency of polypropylene polymers can be improved by incorporating ethylene into the polymer chain to generate a polypropylene-ethylene random copolymer and further improved by adding a nucleator (clarifier).

Although nucleated (clarified) polypropylene-ethylene random copolymers have excellent initial transparency properties, when subjected to high temperatures for a period of time, small molecules in the polymer are known to migrate to the surface, which is defined as blooming. Blooming can negatively affect the organoleptic and optical properties of the polymer and of articles made from the polymer. For example, blooming can have a negative impact on transparency which can be measured as haze. Many nucleated (clarified) propylene-ethylene random copolymers, for instance, display low haze at room temperature but undergo a substantial increase in haze after exposure to high temperatures.

In view of the above drawbacks, propylene-ethylene random copolymers are not well suited for use in applications where exposure to high temperatures are required. For example, propylene-ethylene random copolymers are not always well suited to producing molded articles, such as food packaging, medical packaging, and medical devices, that are subjected to high temperature sterilization, such as steam sterilization and retort processing.

In view of the above, a need exists for a polypropylene polymer and a polypropylene composition that can maintain excellent transparency characteristics even when subjected to heat cycles or high temperatures during use.

### SUMMARY

In general, the present disclosure is directed to a polymer composition containing a propylene-butene copolymer. The polymer composition can be used to make numerous and different articles, including food packaging, medical packaging, medical devices, various containers, and the like. The propylene-butene copolymer of the present disclosure has been found to not only have excellent stiffness properties, but also has great optical properties by displaying low haze, especially when containing a nucleating agent. (Of particular advantage, the nucleated propylene-butene copolymer has been found to have bloom-resistant properties and therefore can maintain its clarity properties even when subjected to higher temperatures, such as during sterilization processes. Thus, the propylene-butene copolymers of the present disclosure offer various advantages over many conventional propylene-ethylene copolymers developed in the past.

In one embodiment, for instance, the present disclosure is directed to a polymer composition containing a propylene-butene copolymer. The propylene-butene copolymer can include propylene as a primary monomer and can contain butene in an amount from about 1% to about 12% by weight, such as in an amount from about 2% to about 8% by weight, such as in an amount from about 3% to about 6% by weight. The propylene-butene copolymer can have a xylene soluble fraction of from about 1% to about 8%, such as from about 2% to about 6% by weight. The polymer can have a xylene soluble fraction/butene content ratio of from about 0.3 to about 3.0, such as from about 0.3 to about 2.0, such as from about 0.5 to about 1.0. The copolymer can be formed using a non-phthalate based Ziegler-Natta catalyst and can have a molecular weight distribution of greater than about 3.5.

In addition to the propylene-butene copolymer, the polymer composition can also contain a nucleating agent, such as a clarifying agent. The polymer composition can display a haze at 1 mm of less than about about 25%, such as less than about 20%, such as less than about 18%, such as less than about 15%, such as less than about 13%, such as less than about 10%, such as even less than about 8%. The polymer composition can display a haze at 0.7 mm of less than about 20%, such as less than about 18%, such as less than about 15%, such as less than about 13%, such as less than about 12%, such as even less than about 10%. In addition, when subjected to thermal aging for 30 minutes at 121° C. or for 24 hours at 55° C., the haze of the polymer composition may increase by no more than about 35%, such as by no more than about 30%, such as by no more than about 20%, such as by no more than about 18%, such as by no more than about 15%, such as by no more than about 10%.

The propylene-butene copolymer can also have superior heat resistant properties especially when containing lower amounts of butene. The polymer can generally have a heat deflection temperature of greater than about 70° C. When containing butene in an amount less than about 8% by weight, such as less than 6% by weight, the copolymer can have a heat deflection temperature of greater than about 75° C. and can have a melting point of greater than about 135° C., such as from about 143° C., to about 165° C., such as from about 145° C. to about 155° C. The propylene-butene copolymer can have a melt flow rate of anywhere from about 0.2 g/10 min to about 220 g/10 min., such as from about 2 g/10 min to about 60 g/10 min.

The polymer composition can contain the propylene-butene copolymer in an amount generally greater than about 70% by weight, such as in an amount greater than about 80% by weight, such as in an amount greater than about 90% by weight, such as in an amount greater than about 95% by weight. The nucleating agent combined with the propylene-butene copolymer can be a clarifier such as a nonitol. The nucleating agent can be present in the polymer composition in an amount greater than about 100 ppm, such as in an amount greater than about 300 ppm, such as in an amount greater than about 1000 ppm, such as in an amount greater than about 2000 ppm, and generally less than about 20,000 ppm, such as less than about 10,000 ppm, such as less than about 4000 ppm.

The polymer composition of the present disclosure can be used to produce numerous and diverse polymer articles using any suitable melt processing technique. For instance, the articles can be injection molded, blow molded, or thermoformed. The polymer composition, for instance, can be used to produce containers, food packaging, medical packaging, medical devices, and the like.

Other features and aspects of the present disclosure are discussed in greater detail below.

### DETAILED DESCRIPTION

The present disclosure is generally directed to a polymer composition having excellent optical properties. The polymer composition can also be formulated to have excellent stiffness characteristics. The polymer composition of the present disclosure generally contains a propylene-butene copolymer. The clarified propylene-butene copolymer has been found to have excellent haze characteristics even after being subjected to high temperatures. Consequently, the polymer composition is particularly well suited to producing transparent articles that are typically subjected to high temperatures during use. For example, many food packages, medical packages, and medical devices are subjected to a high temperature sterilization, such as steam sterilization, and/or retort processing.

In the past, nucleated (clarified) propylene-ethylene random copolymers were typically selected for producing articles with transparency. However, in order to produce a polymer article that will retain its transparency over time, the propylene-ethylene copolymers typically were formulated to contain very small amounts of xylene soluble fractions and typically were required to have a low xylene soluble to ethylene content ratio in order to minimize blooming during heat aging. In contrast, the propylene-butene copolymers of the present disclosure have been found to have greater resistance to haze deterioration even when subjected to high temperatures.

Polymer compositions made in accordance with the present disclosure can be formulated by combining together a propylene-butene random copolymer and a nucleating or clarifying agent. The resulting polymer composition can display a haze at 1 mm of less than about 25%, such as less than about 20%, such as less than about 18%, such as less than about 15%, such as less than about 13%, such as less than about 12%, such as less than about 10%, such as less than about 8%. The resulting polymer composition can display a haze at 0.7 mm of less than about 20%, such as less than about 18%, such as less than about 15%, such as less than about 13%, such as less than about 12%, such as less than about 10%. Articles made with the polymer, such as containers, cups and bottles, can display a haze of less than about 10%, such as less than about 8%, such as less than about 7%, such as less than 6%, such as less than about 4%, especially at a wall thickness of less than about 0.5 mm. The haze is generally greater than 0.5%. Of particular advantage, when subjected to thermal aging for 30 minutes at 121° C., the haze of the polymer composition increases by no more than about 35%, such as by no more than about 30%, such as by no more than about 25%, such as by no more than about 20%, such as by no more than about 15%, such as by no more than about 12%, such as by no more than about 10%, such as by no more than about 8%. When subjected to thermal aging for 24 hours at 55° C., the haze of the polymer composition increases by no more than about 30%, such as by no more than about 25%, such as by no more than about 20%, such as by no more than about 17%, such as by no more than about 15%, such as by no more than about 13%, such as by no more than about 10%. These results are dramatic in comparison to many propylene-ethylene random copolymers made in the past.

Another advantage of the polymer composition of the present disclosure is that the propylene-butene random copolymer can be produced over a very broad melt flow rate range. For instance, the melt flow rate can be from about 0.2 g/10 min to about 220 g/10 min, such as from about 1 g/10 min to about 60 g/10 min. In this manner, the polymer composition is well suited for use in all different types of molding processes. For instance, the polymer composition can be used in injection molding, blow molding, and thermoforming. For example, blow molded or thermoformed articles can be made from the polymer composition having a melt flow rate of from about 0.2 g/10 min, to about 6 g/10 min. Articles that can be made in accordance with the present disclosure include all different types of films, food packaging, medical instrument packaging, medical devices, all different types of containers, and the like.

### I. DEFINITIONS AND TESTING PROCEDURES

The term “propylene-butene copolymer”, as used herein, is a copolymer containing a majority weight percent propylene monomer with butene monomer as a secondary constituent. A “propylene-butene copolymer” (also sometimes referred to as a polypropylene-butene random copolymer), is a polymer having individual repeating units of the butene monomer present in a random or statistical distribution in the polymer chain.

Melt flow rate (MFR), as used herein, is measured in accordance with the ASTM D1238 test method at 230° C. with a 2.16 kg weight for propylene-based polymers. The melt flow rate can be measured in pellet form or on the reactor powder. When measuring the reactor powder, a stabilizing package can be added including 2000 ppm of CYANOX 2246 antioxidant (methylenebis(4-methyl-6-tert-butylphenol) 2000 ppm of IRGAFOS 168 antioxidant (tris(2,4-di-tert-butylphenyl)phosphite) and 1000 ppm of acid scavenger ZnO.

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-06 using a 60 minute precipitation time and is also referred to herein as the “wet method”.

The ASTM D5492-06 method mentioned above may be adapted to determine the xylene soluble portion. In general, the procedure consists of weighing 2 g of sample and dissolving the sample in 200 ml o-xylene in a 400 ml flask with 24/40 joint. The flask is connected to a water cooled condenser and the contents are stirred and heated to reflux under nitrogen (N2), and then maintained at reflux for an additional 30 minutes. The solution is then cooled in a temperature controlled water bath at 25° C. for 60 minutes to allow the crystallization of the xylene insoluble fraction. Once the solution is cooled and the insoluble fraction precipitates from the solution, the separation of the xylene soluble portion (XS) from the xylene insoluble portion (XI) is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)=[(m3−m2)*2/m1]*100, where m1 is the original weight of the sample used, m2 is the weight of empty aluminum pan, and m3 is the weight of the pan and residue (the asterisk, *, here and elsewhere in the disclosure indicates that the identified terms or values are multiplied).

XS can also be measured according to the Viscotek method, as follows: 0.4 g of polymer is dissolved in 20 ml of xylenes with stirring at 130° C. for 60 minutes. The solution is then cooled to 25° C. and after 60 minutes the insoluble polymer fraction is filtered off. The resulting filtrate is analyzed by Flow Injection Polymer Analysis using a Viscotek ViscoGEL H-1100-3078 column with THF mobile phase flowing at 1.0 ml/min. The column is coupled to a Viscotek Model 302 Triple Detector Array, with light scattering, viscometer and refractometer detectors operating at 45° C. Instrument calibration is maintained with Viscotek PolyCAL™ polystyrene standards. A polypropylene (PP) homopolymer, such as biaxially oriented polypropylene (BOPP) grade Dow 5D98, is used as a reference material to ensure that the Viscotek instrument and sample preparation procedures provide consistent results. The value for the reference polypropylene homopolymer, such as 5D98, is initially derived from testing using the ASTM method identified above.

The term “tacticity” generally refers to the relative stereochemistry of adjacent chiral centers within in a macromolecule or polymer. For example, in a propylene-based polymer, the chirality of adjacent monomers, such as two propylene monomers, can be of either like or opposite configuration. The term “diad” is used to designate two contiguous monomers and three adjacent monomers are called a “triad.” If the chirality of adjacent monomers is of the same relative configuration, the diad is considered isotactic; if opposite in configuration, it is termed syndiotactic. Another way to describe the configurational relationship is to term contiguous pairs of monomers having the same chirality as meso (m) and those of opposite configuration racemic (r).

Tacticity or stereochemistry of macromolecules generally and polypropylene or polypropylene random copolymers in particular can be described or quantified by referring to triad concentration. An isotactic triad, typically identified with the shorthand reference “mm”, is made up of two adjacent meso diads, which have the same configuration, and so the stereoregularity of the triad is identified as “mm”. If two adjacent monomers in a three-monomer sequence have the same chirality and that is different from the relative configuration of the third unit, this triad has ‘mr’ tacticity. An ‘rr’ triad has the middle monomer unit having an opposite configuration from either neighbor. The fraction of each type of triad in the polymer can be determined and when multiplied by 100 indicates the percentage of that type found in the polymer. The mm percentage is used to identify and characterize the polymers herein.

The sequence distribution of monomers in the polymer may be determined by ¹³C-NMR, which can also locate butene residues in relation to the neighboring propylene residues. ¹³C NMR can be used to measure butene content, triad distribution, and triad tacticity, and is performed as follows:

The samples are prepared by adding approximately 2.7 g of a 50/50 mixture of tetrachloroethane-d2/orthodichlorobenzene containing 0.025 M Cr(AcAc)3 to 0.20 g sample in a Norell 1001-7 10 mm NMR tube. The samples are dissolved and homogenized by heating the tube and its contents to 150° C. using a heating block. Each sample is visually inspected to ensure homogeneity.

The data are collected using a Bruker 400 MHz spectrometer equipped with a Bruker Dual DUL high-temperature CryoProbe. The data are acquired using 512 transients per data file, a 6 sec pulse repetition delay, 90 degree flip angles, and inverse gated decoupling with a sample temperature of 120° C. All measurements are made on non-spinning samples in locked mode. Samples are allowed to thermally equilibrate for 10 minutes prior to data acquisition. Percent mm tacticity and weight % butene are calculated according to methods commonly used in the art, which is briefly summarized as follows.

With respect to measuring the chemical shifts of the resonances, the methyl group of the third unit in a sequence of 5 contiguous propylene units consisting of head-to-tail bonds and having the same relative chirality is set to 21.83 ppm. The chemical shift of other carbon resonances are determined by using the above-mentioned value as a reference. The spectrum relating to the methyl carbon region (17.0-23 ppm) can be classified into the first region (21.1-21.9 ppm), the second region (20.4-21.0 ppm), the third region (19.5-20.4 ppm) and the fourth region (17.0-17.5 ppm). Each peak in the spectrum is assigned with reference to a literature source such as the articles in, for example, Polymer, T. Tsutsui et al., Vol. 30, Issue 7, (1989) 1350-1356 and/or Macromolecules, H. N. Cheng, 17 (1984) 1950-1955, the contents of which are incorporated herein by reference.

For convenience, butene content is also measured using a Fourier Transform Infrared method (FTIR) which is correlated to butene values determined using ¹³C NMR, noted above, as the primary method. The relationship and agreement between measurements conducted using the two methods is described in, e.g., J. R. Paxson, J. C. Randall, “Quantitative Measurement of Ethylene Incorporation into Propylene Copolymers by Carbon-13 Nuclear Magnetic Resonance and Infrared Spectroscopy”, Analytical Chemistry, Vol. 50. No. 13, November, 1978, 1777-1780.

The Flexural modulus is determined in accordance with ASTM D790-10 Method A at 1.3 mm/min, using a Type I specimen per ASTM 3641 and molded according to ASTM D4101.

IZOD impact strength is measured in accordance with ASTM D 256 and D4101.

Haze is determined according to ASTM Test D1003, procedure A using the latest version of the test. Haze can be measured on test plaques or on molded articles, such as containers, cups or bottles. Haze can be measured before and after thermal aging. Haze can be measured using a BYK Gardner Haze-Gard Plus 4725 instrument. Injection molded test samples that are tested for haze measurements can be injection molded at a temperature of from 200 to 230 C when a nonitol is present as a nucleating agent, at a temperature of from 250 to 260 C when a sorbitol is present as a nucleating agent, or at a temperature from 200 to 260 C when a non-soluble, particulate nucleating agent is present. Thermal aging is conducted by placing the samples in an oven at the desired temperature (e.g 121 C or 55 C) and for a desired time (e.g. 30 min. or 24 hours) and then retesting for haze.

The heat distortion temperature (HDT) is determined according to ASTM Test D648 entitled deflection temperature of plastics under flexural load, 66 psi on samples prepared/aged according to D4101.

The melting point or melting temperature and the crystallization temperature are determined using differential scanning calorimetry (DSC). The melting point is the primary peak that is formed during the test and is typically the second peak that forms. The term “crystallinity” refers to the regularity of the arrangement of atoms or molecules forming a crystal structure. Polymer crystallinity can be examined using DSC. Tₘₑ means the temperature at which the melting ends and Tₘₐₓ means the peak melting temperature, both as determined by one of ordinary skill in the art from DSC analysis using data from the final heating step. One suitable method for DSC analysis uses a model Q1000™ DSC from TA Instruments, Inc. Calibration of the DSC is performed in the following manner. First, a baseline is obtained by heating the cell from −90° C. to 290° C. without any sample in the aluminum DSC pan. Then 7 milligrams of a fresh indium sample is analyzed by heating the sample to 180° C., cooling the sample to 140° C. at a cooling rate of 10° C./min followed by keeping the sample isothermally at 140° C. for 1 minute, followed by heating the sample from 140° C. to 180° C. at a heating rate of 10° C./min. The heat of fusion and the onset of melting of the indium sample are determined and checked to be within 0.5° C. from 156.6° C. for the onset of melting and within 0.5 J/g from 28.71 J/g for the heat of fusion. Then deionized water is analyzed by cooling a small drop of fresh sample in the DSC pan from 25° C. to −30° C. at a cooling rate of 10° C./min. The sample is kept isothermally at −30° C. for 2 minutes and heated to 30° C., at a heating rate of 10° C./min. The onset of melting is determined and checked to be within 0.5° C. from 0° C.

### II. PROPYLENE-BUTENE RANDOM COPOLYMER AND COMPOSITIONS

Propylene-butene copolymers of the present disclosure can include a majority weight percent propylene monomer with a butene monomer as a secondary constituent. The butene content of the propylene-butene copolymer of the present disclosure can be from about 1% to about 12% by weight including all increments of 0.1% by weight therebetween. For example, the propylene-butene copolymer can contain butene in an amount greater than about 1.5% by weight, such as greater than about 2% by weight, such as greater than about 2.3% by weight, such as greater than about 3% by weight, such as greater than about 4% by weight, such as greater than about 4.5% by weight, such as greater than about 5% by weight. The butene content of the propylene-butene copolymer is generally less than about 11% by weight, such as less than about 10% by weight, such as less than about 0% by weight, such as less than about 8% by weight, such as less than about 7.8% by weight, such as less than about 7% by weight, such as less than about 6% by weight, such as less than about 5% by weight. The amount of butene incorporated into the copolymer can be varied in order to change various physical properties of the polymer.

The xylene soluble (XS) fraction for the copolymers of the present disclosure can be less than or equal to (≤)8.0% by weight of the copolymer, or ≤7.0% by weight, more preferably ≤6.0% by weight, and still more preferably ≤5.0% by weight. The xylene soluble fraction is generally greater than about 0.5% by weight, such as greater than about 1% by weight. The xylene soluble (XS) fraction is preferably in the range of from 1.0% to 8.0% by weight, such as from 2% to 7% by weight. The polymer can have a xylene soluble fraction/butene content ratio of from about 0.3 to about 3.0, such as from about 0.3 to about 2.0, such as from about 0.5 to about 1.0 or less than 1.0. Of particular advantage, propylene-butene copolymers in accordance with the present disclosure can have xylene soluble contents of greater than about 3% by weight while still having excellent clarity property.

The melt flow rate of propylene-butene copolymers made in accordance with the present disclosure can vary. For instance, the melt flow rate can be from about 0.2 g/10 min to about 220 g/10 min, including all increments of 1 therebetween. The melt low rate of the polymer, for instance, can be varied and controlled based upon various factors and the desired application. When the polymer is incorporated into the composition and blow molded, for instance, lower melt flow rates may be desired. For instance, in one aspect, the melt flow rate of the propylene-butene copolymer can be less than about 20 g/10 min, such as less about 15 g/10 min, such as less about 10 g/10 min, such as less than about 8 g/10 min, such as less about 6 g/10 min, such as less about 4 g/10 min, and generally greater than about 1 g/10 min, such as greater than about 2 g/10 min. When the polymer is used in injection molding and/or thermoforming, however, a higher melt flow rate may be desired. For example, in one aspect, the melt flow rate of the polymer can be greater than about 10 g/10 min, such as greater than about 20 g/10 min, such as greater than about 30 g/10 min, such as greater than about 40 g/10 min, and generally less than about 110 g/10 min, such as less than 80 g/10 min, such as less than about 60 g/10 min.

The copolymer of the present disclosure generally has a relatively broad molecular weight distribution. For instance, the molecular weight distribution (Mw/Mn) is generally greater than about 3.5, such as greater than about 3.8, such as greater than about 4, such as greater than about 4.3, such as greater than about 4.5, such as greater than about 4.8, such as greater than about 5, such as greater than about 5.2, such as greater than about 5.5, such as greater than about 5.7, such as greater than about 6 and is generally less than about 10, such as less than about 8, such as less than about 7.5. The weight average molecular weight is determined by GPC.

In one aspect, the propylene-butene copolymer can be formulated to have excellent stiffness properties. For instance, the copolymer can have a flexural modulus of greater than about 1000 MPa, such as greater than about 1100 MPa, such as greater than about 1150 MPa, such as greater than about 1200 MPa, such as greater than about 1250 MPa, such as greater than about 1300 MPa, such as greater than about 1350 MPa, such as greater than about 1400 MPa, such as greater than about 1450 MPa, such as greater than about 1500 MPa. The flexural modulus is generally less than about 3000 MPa, such as less than about 2000 MPa.

Of particular advantage, the propylene-butene random copolymer can have a high heat deflection resistance, especially when the polymer is formulated to contain butene in lower amounts. In general, the polymer can have a heat deflection temperature (HDT) of greater than about 70° C. When containing butene in an amount less than 8% by weight, such as in an amount less than 6% by weight, such as in an amount less than 5% by weight, the HDT can be greater than about 75° C., such as greater than about 76° C., such as greater than about 77° C., and generally less than about 90° C. In addition, the polymer can be formulated to have a melting point of greater than about 135° C., such as greater than about 143° C., such as greater than about 145° C., such as greater than about 147° C., such as greater than about 149° C., such as greater than about 150° C., such as greater than about 151° C., and generally less than about 165° C. In one aspect, the polymer can have a primary melting point of no less than 147° C.

In addition to excellent stiffness properties and heat resistance properties, the propylene-butene copolymer can also have good toughness characteristics. For instance, the copolymer can have an IZOD impact strength of greater than about 40 J/m, such as greater than about 45 J/m, such as greater than about 50 J/m, such as greater than about 55 J/m, such as greater than about 60 J/m, such as greater than about 65 J/m, such as greater than about 70 J/m, such as greater than about 75 J/m, such as greater than about 80 J/m, such as greater than about 85 J/m, such as greater than about 90 J/m. The impact strength is generally less than about 200 J/m, such as less than about 150 J/m.

### III. PROPYLENE-BUTENE RANDOM COPOLYMER PRODUCTION

In one aspect, the propylene-butene copolymers of the present disclosure can be produced using non-phthalate based Ziegler-Natta catalysts. A non-phthalate based catalyst includes a catalyst system that contains no phthalate compounds, e.g. catalyst support, internal electron donors, external electron donors, activity limiting agent and activator are all phthalate free. Phthalates were used in the past as internal electron donors. Non-phthalate internal electron donors include diethers, succinates, ethyl benzoates, phenylene diesters, and the like. By using a non-phthalate based catalyst, the polymers are suited for food contact and medical applications. In addition, using a Ziegler-Natta catalyst can produce a broad molecular weight distribution that can provide numerous advantages and benefits.

Propylene-butene copolymers can generally be made in any suitable reactor using any suitable process to produce the propylene based polymers. This includes the UNIPOL® gas phase process, using a supported Ziegler-Natta catalyst. Particularly preferable are CONSISTA® catalysts available from W.R. Grace & Co., Columbia, Md. Suitable polypropylene random copolymers may be produced using a single reactor or multiple reactors. Examples of processes that may be used are described in U.S. Pat. No. 9,624,323 and US Patent Publication No. 2016/0289357, which are incorporated herein by reference.

Procatalyst compositions suitable for use in producing the polypropylene random copolymers include Ziegler-Natta procatalyst compositions. In an embodiment, the Ziegler-Natta procatalyst composition contains a titanium moiety such as titanium chloride, a magnesium moiety such as magnesium chloride, and an internal electron donor.

In an embodiment, the internal electron donor comprises a substituted phenylene aromatic diester. In an embodiment, a 1,2-phenylene aromatic diester is provided. The substituted 1,2-phenylene aromatic diester has the structure (I) below:

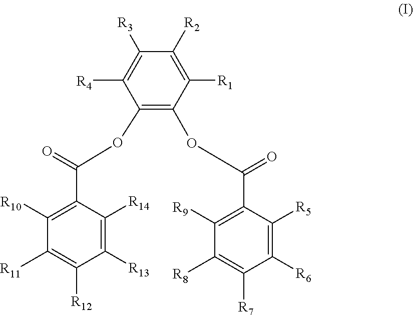

wherein R₁-R₁₄ are the same or different. Each of R₁-R₁₄ is selected from a hydrogen, substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. At least one of R₁-R₁₄ is not hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

The procatalyst precursor can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable procatalyst precursors include halides, oxyhalides, and alkoxides of magnesium, manganese, titanium, vanadium, chromium, molybdenum, zirconium, hafnium, and combinations thereof.

In an embodiment, the procatalyst precursor is a magnesium moiety compound (MagMo), a mixed magnesium titanium compound (MagTi), or a benzoate-containing magnesium chloride compound (BenMag). In an embodiment, the procatalyst precursor is a magnesium moiety (“MagMo”) precursor. The “MagMo precursor” contains magnesium as the sole metal component. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In an embodiment, the procatalyst precursor is a mixed magnesium/titanium compound (“MagTi”). The “MagTi precursor” has the formula Mg_{d}Ti(OR^{e})_{f}X_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation results in precipitation of the solid precursor, having especially desirable morphology and surface area. Moreover, the resulting precursors are particularly uniform in particle size.

In one embodiment, the procatalyst precursor contains magnesium as the sole metal component. Non-limiting examples include anhydrous magnesium chloride and/or its alcohol adduct, magnesium alkoxide, and or aryloxide, mixed magnesium alkoxy halide, and/or carboxylated magnesium dialkoxide or aryloxide.

In one embodiment, the procatalyst precursor is an alcohol adduct of anhydrous magnesium chloride. The anhydrous magnesium chloride adduct is generally defined as MgCl₂-nROH where n has a range of 1.5-6.0, preferably 2.5-4.0, and most preferably 2.8-3.5 moles total alcohol. ROH is a C₁-C₄ alcohol, linear or branched, or mixture of alcohol. Preferably ROH is ethanol or a mixture of ethanol and a higher alcohol. If ROH is a mixture, the mole ratio of ethanol to higher alcohol is at least 80:20, preferably 90:10, and most preferably at least 95:5.

In one embodiment, a substantially spherical MgCl₂-nEtOH adduct may be formed by a spray crystallization process. In one, embodiment the spherical MgCl₂ precursor has an average particle size (Malvern d₅₀) of between about 15-150 microns, preferably between 20-100 microns, and most preferably between 35-85 microns.

In one embodiment, the procatalyst precursor contains a transition metal compound and a magnesium metal compound. The transition metal compound has the general formula TrXₓ where Tr is the transition metal, X is a halogen or a C₁₋₁₀ hydrocarboxyl or hydrocarbyl group, and x is the number of such X groups in the compound in combination with a magnesium metal compound. Tr may be a Group IV, V or VI metal. In one embodiment, Tr is a Group IV metal, such as titanium. X may be chloride, bromide, C₁₋₄ alkoxide or phenoxide, or a mixture thereof. In one embodiment, X is chloride.

The present procatalyst composition can also include an internal electron donor. As used herein, an “internal electron donor” is a compound added during formation of the procatalyst composition that donates a pair of electrons to one or more metals present in the resultant procatalyst composition. Not bounded by any particular theory, it is believed that the internal electron donor assists in regulating the formation of active sites and thus enhances catalyst stereoselectivity. In an embodiment, the internal electron donor includes a substituted phenylene aromatic diester of structure (I), identified above.

In an embodiment, a procatalyst composition is provided which includes a combination of a magnesium moiety, a titanium moiety and an internal electron donor. The internal electron donor includes the substituted phenylene aromatic diester. The procatalyst composition is produced by way of a halogenation procedure described in detail in U.S. Pat. No. 8,536,372, incorporated herein by reference, which converts the procatalyst precursor and the substituted phenylene aromatic diester donor into the combination of the magnesium and titanium moieties, into which the internal electron donor is incorporated. The procatalyst precursor from which the procatalyst composition is formed can be the magnesium moiety precursor, the mixed magnesium/titanium precursor, or the benzoate-containing magnesium chloride precursor.

In an embodiment, the magnesium moiety is a magnesium halide. In another embodiment, the magnesium halide is magnesium chloride, or magnesium chloride alcohol adduct. In an embodiment, the titanium moiety is a titanium halide such as a titanium chloride. In another embodiment the titanium moiety is titanium tetrachloride. In another embodiment, the procatalyst composition includes a magnesium chloride support upon which a titanium chloride is deposited and upon which the internal electron donor is incorporated.

In an embodiment, the internal electron donor of the procatalyst composition includes the substituted phenylene aromatic diester of structure (I), illustrated above, wherein R₁-R₁₄ are the same or different: each of R₁-R₁₄ is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof; and at least one of R₁-R₁₄ is not hydrogen.

In an embodiment, at least one (or two, or three, or four) R group(s) of R₁-R₄ is selected from a substituted hydrocarbyl group having 1 to 20 carbon atoms, an unsubstituted hydrocarbyl group having 1 to 20 carbon atoms, an alkoxy group having 1 to 21) carbon atoms, a heteroatom, and combinations thereof.

In an embodiment, at least one (or some, or all) R group(s) of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. In another embodiment, at least one of R₅-R₉ and at least one of R₁₀-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In an embodiment, at least one of R₁-R₄ and at least one of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. In another embodiment, at least one of R₁-R₄ at least one R₅-R₉ of and at least one of R₁₀-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In an embodiment, any consecutive R groups in R₁-R₄, and/or any consecutive R groups in R₅-R₉, and/or any consecutive R groups in R₁₀-R₁₄ may be linked to form an inter-cyclic or an intra-cyclic structure. The inter-/intra-cyclic structure may or may not be aromatic. In an embodiment, the inter-/intra-cyclic structure is a C₅ or a C₆ membered ring.

In an embodiment, at least one of R₁-R₄ is selected from a substituted hydrocarbyl group having 1 to 20 carbon atoms, an unsubstituted hydrocarbyl group having 1 to 20 carbon atoms, and combinations thereof. Optionally, at least one of R₅-R₁₄ may be a halogen atom or an alkoxy group having 1 to 20 carbon atoms. Optionally, R₁-R₄, and/or R₅-R₉, and/or R₁₀-R₁₄ may be linked to form an inter-cyclic structure or an intra-cyclic structure. The inter-cyclic structure and/or the intra-cyclic structure may or may not be aromatic.

In an embodiment, any consecutive R groups in R₁-R₄, and/or in R₅-R₉, and/or in R₁₀-R₁₄, may be members of a C₅-C₆-membered ring.

In an embodiment, structure (I) includes R₁, R₃ and R₄ as hydrogen. R₂ is selected from a substituted hydrocarbyl group having 1 to 20 carbon atoms, an unsubstituted hydrocarbyl group having 1 to 20 carbon atoms, and combinations thereof. R₅-R₁₄ are the same or different and each of R₅-R₁₄ is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In an embodiment, R₂ is selected from a C₁-C₈ alkyl group, a C₃-C₆ cycloalkyl, or a substituted C₃-C₆ cycloalkyl group. R₂ can be a methyl group, an ethyl group, a n-propyl group, an isopropyl group, a t-butyl group, an isobutyl group, a sec-butyl group, a 2,4,4-trimethylpentan-2-yl group, a cyclopentyl group, and a cyclohexyl group.

In an embodiment, structure (I) includes R₂ that is methyl, and each of R₅-R₁₄ is hydrogen. In an embodiment, structure (I) includes R₂ that is ethyl, and each of R₅-R₁₄ is hydrogen. In an embodiment, structure (I) includes R₂ that is t-butyl, and each of R₅-R₁₄ is hydrogen. In an embodiment, structure (I) includes R₂ that is ethoxycarbonyl, and each of R₅-R₁₄ is hydrogen.

In an embodiment, structure (I) includes R₂, R₃ and R₄ each as hydrogen and R₃ is selected from a substituted hydrocarbyl group having 1 to 20 carbon atoms, an unsubstituted hydrocarbyl group having 1 to 20 carbon atoms, and combinations thereof. R₅-R₁₄ are the same or different and each is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In an embodiment, structure (I) includes R₁ that is methyl, and each of R₅-R₁₄ is hydrogen.

In an embodiment, structure (I) includes R₂ and R₄ that are hydrogen and R₁ and R₃ are the same or different. Each of R₁ and R₃ is selected from a substituted hydrocarbyl group having 1 to 20 carbon atoms, an unsubstituted hydrocarbyl group having 1 to 20 carbon atoms, and combinations thereof. R₅-R₁₄ are the same or different and each of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In an embodiment, structure (I) includes R₁ and R₃ that are the same or different. Each of R₁ and R₃ is selected from a C₁-C₈ alkyl group, a C₃-C₆ cycloalkyl group, or a substituted C₃-C₆ cycloalkyl group. R₅-R₁₄ are the same or different and each of R₅-R₁₄ is selected from hydrogen, a C₁-C₈ alkyl group, and a halogen. Nonlimiting examples of suitable C₁-C₈ alky) groups include methyl, ethyl, n-propyl, isopropyl, n-butyl, i-butyl, t-butyl, n-pentyl, i-pentyl, neopentyl, t-pentyl, n-hexyl, and 2,4,4-trimethylpentan-2-yl group. Nonlimiting examples of suitable C₃-C₆cycloalkyl groups include cyclopentyl and cyclohexyl groups. In a further embodiment, at least one of R₅-R₁₄ is a C₁-C₈ alkyl group or a halogen.

In an embodiment, structure (I) includes R₁ that is a methyl group and R₃ that is a t-butyl group. Each of R₂, R₄ and R₅-R₁₄ is hydrogen.

In an embodiment, structure (I) includes R₁ and R₄ as methyl groups and one of R₃ or R₂ is a hydrogen and the other is a cycloalkyl group, such as a cyclohexal group.

In an embodiment, structure (I) includes R₁ and R₃ that is an isopropyl group. Each of R₂, R₄ and R₅-R₁₄ is hydrogen.

In an embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇, and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇, and R₁₂ is a fluorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group. Each of R₂, R₄ and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄ and R₅-R₁₄ is hydrogen.

In an embodiment, structure (I) includes R₁ and R₃, each of which is a sec-butyl group. Each of R₂, R₄ and R₅-R₁₄ is hydrogen.

In an embodiment, structure (I) includes R₁ and R₄ that are each a methyl group. Each of R₂, R₃, R₅-R₉ and R₁₀-R₁₄ is hydrogen.

In an embodiment, structure (I) includes R₁ that is a methyl group, R₄ is an i-propyl group. Each of R₂, R₃, R₅-R₉ and R₁₀-R₁₄ is hydrogen.

In an embodiment, structure (I) includes R₁, R₃, and R₄, each of which is an i-propyl group. Each of R₂, R₅-R₉ and R₁₀-R₁₄ is hydrogen.

In an embodiment, another procatalyst composition is provided. The procatalyst composition includes a combination of a magnesium moiety, a titanium moiety and a mixed internal electron donor. As used herein, a “mixed internal electron donor” is (i) a substituted phenylene aromatic diester, (ii) an electron donor component that donates a pair of electrons to one or more metals present in the resultant procatalyst composition, and (iii) optionally other components. In an embodiment, the electron donor component is a diether, a benzoate, and combinations thereof. The procatalyst composition with the mixed internal electron donor can be produced by way of the procatalyst production procedure as disclosed in the previously granted patents and publications identified herein.

For example, suitable catalyst compositions comprise a pro-catalyst composition, a co-catalyst, and an external electron donor or a mixed external electron donor (M-EED) of two or more different components. Suitable external donors include one or more activity limiting agents (ALA), one or more selectivity control agents (SCA) or both an ALA and an SCA. As used herein, an “external electron donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 85° C.), A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

In an embodiment, the external electron donor includes an alkoxysilane. The alkoxysilane has the general formula:

SiRₙ(OR′)₄₋ₘ (I)

where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ arylalkyl or aralkyl, C₃₋₁₂cycloalkyl, C₃₋₁₂-branched alkyl, or C₃₋₁₂cyclic or acyclic amino group, R′ is C₁₋₄ alkyl, and m is 1 or 2.

Nonlimiting examples of suitable silane compositions include dicyclopentyldimethoxysilane; di-tert-butyldimethoxysilane; methylcyclohexyldirnethoxysilane; methylcyclohexyldiethoxysilane; ethylcyclohexyldimethoxysilane; diphenyldimethoxysilane; diisopropyldimethoxysilane; di-n-propyldimethoxysilane; diisobutyldimethoxysilane; diisobutyldiethoxysilane; isobutylisopropyldimethoxysilane; di-n-butyldimethoxysilane; cyclopentyltrimethoxysilane; isopropyltrimethoxysilane; n-propyltrimethoxysilane; n-propyltriethoxysilane; ethyltriethoxysilane; tetramethoxysilane; tetraethoxysilane; diethylaminotriethoxysilane; cyclopentylpyrrolidinodimethoxysilane; bis(pyrrolidino)dimethoxysilane; bis(perhydroisoquinolino)dimethoxysilane; and dimethyldimethoxysilane. In an embodiment, the silane composition is dicyclopentyldimethoxysilane (DCPDMS); methylcyclohexyldimethoxysilane (MChDMS); or n-propyltrimethoxysilane (NPTMS); and any combination of thereof.

In an embodiment, the selectivity control agent component can be a mixture of 2 or more alkoxysilanes. In a further embodiment, the mixture can be dicyclopentyldimethoxysilane and methylcyclohexyldimethoxysilane, dicyclopentyldimethoxysilane and tetraethoxysilane, or dicyclopentyldimethoxysilane and n-propyltriethoxysilane. In an embodiment, the mixed external electron donor may include a benzoate, a succinate, and/or a diol ester. In an embodiment, the mixed external electron donor includes 2,2,6,6-tetramethylpiperidine as an SCA. In another embodiment, the mixed external electron donor includes a diether as both an SCA and an ALA.

A mixed external electron donor system can also include an activity limiting agent (ALA). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester, a diether, a poly(alkene glycol), a diol ester, and combinations thereof. The carboxylic acid ester can be an aliphatic or aromatic, mono- or poly-carboxylic acid ester. Nonlimiting examples of suitable monocarboxylic acid esters include ethyl and methyl benzoate; ethyl p-methoxybenzoate; methyl p-ethoxybenzoate; ethyl p-ethoxybenzoate; ethyl p-isopropoxybenzoate; ethyl acrylate; methyl methacrylate; ethyl acetate; ethyl p-chlorobenzoate; hexyl p-aminobenzoate; isopropyl naphthenate; n-amyl toluate; ethyl cyclohexanoate and propyl pivalate.

Nonlimiting examples of suitable polycarboxylic acid esters include diethyl terephthalate; dioctyl terephthalate; and bis[4-(vinyloxy)butyl]terephthalate.

The aliphatic carboxylic acid ester may be a C₆ aliphatic acid ester, may be a mono- or a poly- (two or more) ester, may be straight chain or branched, may be saturated or unsaturated, and any combination thereof. The C₆-C₃₀ aliphatic acid ester may also be substituted with one or more Group 14, 15 or 16 heteroatom containing substituents. Nonlimiting examples of suitable C₆-C₃₀ aliphatic acid esters include Ci₋₂O alkyl esters of aliphatic C₆₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₆₋₂₀ mono- or polycarboxylate derivatives of C₂₋₁₀₀ (poly) glycols or C₂₋₁₀₀ (poly)glycol ethers. In a further embodiment, the C₆-C₃₀ aliphatic acid ester may be a laurate, a myristate, a palmitate, a stearate, an oleate, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₆-C₂₀ aliphatic ester is isopropyl myristate or di-n-butyl sebacate.

In an embodiment, the activity limiting agent includes a diether. The diether can be a 1,3-diether compound represented by the following structure (VI):

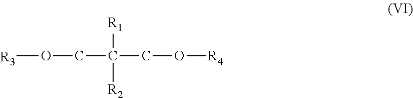

wherein R₁ to R₄ are independently of one another an alkyl, aryl or aralkyl group having up to 20 carbon atoms, which may optionally contain a group 14, 15, 16, or 17 heteroatom, and R₁ and R₂ may be a hydrogen atom. The dialkylether may linear or branched, and may include one or more of the following groups: alkyl, cycloaliphatic, aryl, alkylaryl or arylalkyl radicals with 1-18 carbon atoms, and hydrogen. R₁ and R₂ may be linked to form a cyclic structure, such as cyclopentadiene or fluorene.

In an embodiment, the activity limiting agent includes a succinate composition having the following structure (VII):

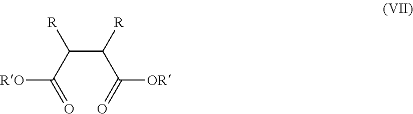

wherein R and R′ may be the same or different, R and/or R′ including one or more of the following groups: hydrogen, linear or branched alkyl, alkenyl, cycloalkyl, aryl, arylalkyl or alkylaryl group, optionally containing heteroatoms. One or more ring structures can be formed via one or both 2- and 3-position carbon atom.

In an embodiment, the activity limiting agent includes a diol ester as represented by the following structure (VIII):

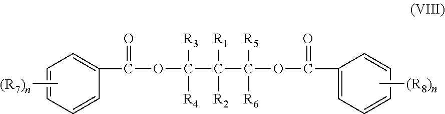

wherein n is an integer from 1 to 5. R₁ and R₂, may be the same or different, and each may be selected from hydrogen, methyl, ethyl, n-propyl, i-propyl, n-butyl, i-butyl, t-butyl, allyl, phenyl, or halophenyl group. R₃, R₄, R₅, R₆, R₇, and R₈ may be the same or different, and each may be selected from hydrogen, halogen, substituted, or unsubstituted hydrocarbyl having 1 to 20 carbon atoms. R₁-R₆ groups may optionally contain one or more heteroatoms replacing carbon, hydrogen or both, the hetero-atom selected from nitrogen, oxygen, sulfur, silicon, phosphorus and a halogen. R₇ and R₈, may be the same or different, and may be bonded to any carbon atom of the 2-, 3-, 4-, 5-, and 6-position of either phenyl ring.

Individual external electron donor components can be added into the reactor separately or two or more can be mixed together in advance and then added into the reactor as a mixture. In the mixture, more than one selectivity control agent or more than one activity limiting agent can be used. In an embodiment, the mixture is dicyclopentyldimethoxysilane and isopropyl myristate; diisopropyldimethoxysilane and isopropyl myristate; dicyclopentyldimethoxysilane and poly(ethylene glycol) laurate; dicyclopentyldimethoxysilane and isopropyl myristate and poly(ethylene glycol) dioleate; methylcyclohexyldimethoxysilane and isopropyl myristate; n-propyltrimethoxysilane and isopropyl myristate; dimethyldimethoxysilane and methylcyclohexyldimethoxysilane and isopropyl myristate; dicyclopentyldimethoxysilane and n-propyltriethoxysilane and isopropyl myristate; diisopropyldimethoxysilane and n-propyltriethoxysilane and isopropyl myristate; and dicyclopentyldimethoxysilane and tetraethoxysilane and isopropyl myristate; dicyclopentyldimethoxysilane and diisopropyldimethoxysilane and n-propyltriethoxysilane and isopropyl myristate; and combinations thereof.

The catalyst composition includes a cocatalyst. The cocatalyst for use with the Ziegler-Natta procatalyst composition may be an aluminum containing composition. Nonlimiting examples of suitable aluminum containing compositions include organoaluminum compounds, such as trialkylaluminum; dialkylaluminum hydride; alkylaluminum dihydride; dialkylaluminum halide; alkylaluminumdihalide; dialkylaluminum alkoxide; and alkylaluminum dialkoxide-compounds containing from 1-10, or 1-6 carbon atoms in each alkyl- or alkoxide-group. In an embodiment, the cocatalyst is a C₁₋₄ trialkylaluminum compound, such as triethylaluminum (TEA). The catalyst composition includes a mole ratio of aluminum (Al) to (SCA(s)+ALA(s)) of 0.5-25:1; or 1.0-20:1; or 1.5-15:1; or less than about 6.0; or less than about 5; or less than 4.5. In an embodiment, the Al:(SCA(s)+ALA(s)) mole ratio is 0.5-4.0:1. The total-SCA to ALA mole ratio is 0.01-20:1; 0.10-5.00:1; 0.43-2.33:1; or 0.54-1.85:1; or 0.67-1.5:1.

### IV. APPLICATIONS

The propylene-butene copolymers of the present disclosure can be used in numerous and diverse applications. As described above, the propylene-butene copolymers have excellent stiffness characteristics and excellent transparency properties.

In one embodiment, the propylene-butene copolymers of the present disclosure can be incorporated into a composition for forming injection molded articles, such as containers. When used for injection molding, the polymer can have a melt flow rate of greater than about 4 g/10 min, such as greater than about 20 g/10 min, such as greater than about 30 g/10 min, such as greater than about 35 g/10 min. The containers can have a bottom that defines a hollow interior and a top that includes a flange that seals to the bottom. In addition to containers, in general any injection moldable article can be produced in accordance with the present disclosure that requires a certain degree of rigidity in combination with good optics. For instance, the propylene-butene copolymer of the present disclosure is particularly well suited to producing packaging, including all different types food packaging.

In addition to injection molded articles, the propylene-butene copolymer of the present disclosure can also be used in extrusion blow molding or thermoforming applications. For instance, when formulated with a relatively low melt flow rate, the copolymer displays excellent melt strength allowing for the formation of various different blow molded articles having relatively thin walls. When used for blow molding or thermoforming, the polymer can have a melt flow rate of less than about 5 g/10 min, such as less than about 4.5 g/10 min, such as less than about 4 g/10 min, such as less than about 3.5 g/10 min. The polymer can have a melt flow rate of greater than about 0.2 g/10 min, such as greater than about 1 g/10 min

The propylene-butene copolymer can be used to produce all different types of plastic bottles for containing, for instance, beverages. As described above, because the polymer can be formed from a non-phthalate based catalyst, the polymer is exceptionally well suited for food contact applications.

In still another embodiment, the propylene-butene copolymer of the present disclosure can be used in thermoforming applications. For instance, the polymer can be used to produce thermoformed containers including drink cups. Drink cups made according to the present disclosure, for instance, can be display lower haze and higher stiffness in comparison to cups made with ethylene random copolymers.

The propylene-butene copolymers of the present disclosure can be combined with various other components and ingredients in formulating a polymer composition for making molded articles as described above. For instance, in one embodiment, the polymer composition can contain antioxidants and acid scavengers, and in some applications may preferably also contain other additives such as mold release agents, antistats, slip agents, antiblock agents, processing aids, UV stabilizers, and colorants (pigments). The antioxidant can be a hindered phenol, which may be used with a phosphite stabilizer. Acid scavengers that may be used include a metal stearate such as calcium stearate, a hydrotalcite, or mixtures thereof. Each additive can be present in the composition in an amount of from about 0.01% to about 2% by weight, such as from about 0.1% to about 1% by weight.

In one embodiment, the copolymer composition can further contain a nucleating agent. The nucleating agent can be added to further improve the transparency properties of the composition. In one aspect, the nucleating agent can be a clarifying agent that can comprise a compound capable of producing a gelation network within the composition.

In one embodiment, the nucleating agent may comprise a sorbitol compound, such as a sorbitol acetal derivative. In one embodiment, for instance, the nucleating agent may comprise a dibenzyl sorbitol.

With regard to sorbitol acetal derivatives that can be used as an additive in some embodiments, the sorbitol acetal derivative is shown in Formula (I):

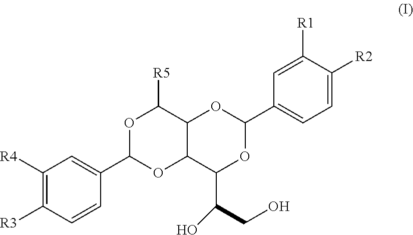

wherein R1-R5 comprise the same or different moieties chosen from hydrogen and a C1-C3 alkyl.

In some embodiments, R1-R5 are hydrogen, such that the sorbitol acetal derivative is 2,4-dibenzylidene sorbitol (“DBS”). In some embodiments, R1, R4, and R5 are hydrogen, and R2 and R3 are methyl groups, such that the sorbitol acetal derivative is 1,3:2,4-di-p-methyldibenzylidene-D-sorbitol (“MDBS”). In some embodiments, R1-R4 are methyl groups and R5 is hydrogen, such that the sorbitol acetal derivative is 1,3:2,4-Bis (3,4-dimethylbenzylidene) sorbitol (“DMDBS”). In some embodiments, R2, R3, and R5 are propyl groups (—CH2-CH2-CH3), and R1 and R4 are hydrogen, such that the sorbitol acetal derivative is 1,2,3-trideoxy-4,6:5,7-bis-O-(4-propylphenyl methylene) nonitol (“TIBPMN”).

Other embodiments of nucleating agents that may be used include:

1,3:2,4-dibenzylidenesorbitol;

1,3:2,4-bis(p-methylbenzylidene)sorbitol;

Di(p-methylbenzylidene)Sorbitol;

Di(p-ethylbenzylidene)Sorbitol; and

Bis(5′,6′,7′,8′-tetrahydro-2-naphtylidene)Sorbitol.

In one embodiment, the nucleating agent may also comprise a bisamide, such as benzenetrisamide. The nucleating agents described above can be used alone or in combination.

The one or more nucleating agents can be present in the polymer composition in an amount greater than about 100 ppm, such as in an amount greater than about 300 ppm, such as in an amount greater than about 1000 ppm, such as in an amount greater than about 2000 ppm, and generally less than about 20,000 ppm, such as less than about 10,000 ppm, such as less than about 4000 ppm.

When the one or more nucleating agents are clarifying agents, the clarifying agents can be added in an amount greater than about 1,500 ppm, such as in an amount greater than about 1,800 ppm, such as in an amount greater than about 2,000 ppm, such as in an amount greater than about 2.200 ppm. One or more clarifying agents are generally present in an amount less than about 20,000 ppm, such as less than about 15,000 ppm, such as less than about 10,000 ppm, such as less than about 8,000 ppm, such as less than about 5,000 ppm.

As described above, polymer compositions containing the propylene-butene copolymer of the present disclosure have excellent low haze characteristics, which can be achieved when one or more nucleating agents are added and combined with the polymer. For example, when measured on at a thickness of 1 mm, the propylene-butene copolymer or polymer composition containing the propylene-butene copolymer can have a haze of less than about 25%, such as less than about 20%, such as less than about 15%, such as less than about 13%, such as less than about 10%. When measured on at a thickness of 0.7 mm, the propylene-butene copolymer or polymer composition containing the propylene-butene copolymer can have a haze of less than about 18%, such as less than about 15%, such as less than about 15%, such as less than about 12%, such as less than about 10%. Molded articles, such as bottles, containers, films, and cups made with the polymer can have a haze of less than about 10%, such as less than about 7.5%, such as less than about 7%, such as less than about 6.5%, such as less than about 6%, such as less than about 5.5%. The haze is generally greater than about 1%.

### V. EXAMPLES

### Example Set No. 1

Propylene-butene random copolymer samples were produced and their properties tested in accordance with the procedures outlined above. The properties and experimental results are outlined in the table below.

The propylene-butene random copolymers were produced with a stereospecific 6^{th} generation Ziegler-Natta magnesium supported/titanium-based catalyst. The catalyst contained a non-phthalate internal donor producing polymers having a broader molecular weight distribution than polymers made using a metallocene catalyst. The process used to produce the polymers is described in the art as the UNIPOL gas phase process. The catalyst used to produce the polymers included a substituted phenylene aromatic diester internal electron donor. The catalyst used is commercially available from W.R. Grace and Company and sold under the trade name CONSISTA. All copolymers were made using an external electron donor and triethylaluminum as a cocatalyst.

The various different random copolymers that were produced were combined with a nucleating agent except for Sample Nos. 1, 6, 10, and 14 where no nucleating agent was added. Two different nucleating agents were used. The nucleating agents were (1) TPBMN (a clarifier) and (2) HYPERFORM HPN-600ei (a nucleator) marketed by Milliken Chemical, Sample Nos. 2, 7, 11, and 15 contained HYPERFORM HPN-600ei at a concentration of 400 ppm. Sample Nos. 3, 8, 12, and 16 contained TPBMN at a concentration of 2000 ppm and Sample Nos. 4, 5, 9, 13, and 17 contained TPBMN at a concentration of 4000 ppm. Each sample also contained a hindered phenol antioxidant, a phosphite antioxidant, and an acid scavenger (hydrotalcite).

The following results were obtained:

| | | | | Tensile | Tensile | | |
|---|---|---|---|---|---|---|---|
| | | IZOD | Flex Mod | Strength | Elongation | | |
| Sample | MFR | (J/M) | @1% Sec | @ yield | @ Yield | % XS | Bt |
| No. | (g/10 min) | @23° C. | (psi) | (psi) | (%) | Viscotek | (% wt) |
| 1 | 3.47 | 41.922 | 192990 | 5252 | 11.5645 | 4.963 | 2.32 |
| 2 | 3.24 | 71.993 | 213640 | 5528 | 10.2826 | 5.16 | 2.43 |
| 3 | 3.00 | 48.697 | 213740 | 5499 | 10.8095 | 5.115 | 2.69 |
| 4 | 3.14 | 59.595 | 220430 | 5569 | 10.8818 | 5.268 | 2.47 |
| 5 | 3.14 | 39.868 | 213390 | 5536 | 10.8089 | 5.119 | 2.62 |
| 6 | 2.83 | 39.729 | 188330 | 4873 | 11.065 | 4.632 | 4.23 |
| 7 | 2.76 | 83.778 | 202670 | 5359 | 10.6176 | 4.759 | 4.22 |
| 8 | 2.84 | 82.035 | 203440 | 5358 | 11.0179 | 4.75 | 4.19 |
| 9 | 3.30 | 56.806 | 211460 | 5431 | 11.2834 | 4.939 | 4.51 |
| 10 | 2.68 | 62.442 | 175320 | 4624 | 11.400 | 4.902 | 5.80 |
| 11 | 2.47 | 85.453 | 187410 | 4839 | 10.798 | 4.684 | 5.90 |
| 12 | 2.52 | 79.571 | 190630 | 4793 | 11.377 | 5.065 | 6.00 |
| 13 | 2.66 | 93.884 | 196950 | 4854 | 11.018 | 4.806 | 6.15 |
| 14 | 2.74 | 69.173 | 164140 | 4431 | 11.415 | 4.347 | 7.66 |
| 15 | 2.85 | 99.446 | 173650 | 4614 | 11.010 | 4.506 | 7.73 |
| 16 | 2.82 | 90.03 | 175420 | 4556 | 11.862 | 4.83 | 7.75 |
| 17 | 3.05 | 90.514 | 180360 | 4632 | 11.462 | 4.615 | 7.75 |

| Sample | ΔH Tc | Tc | ΔH Tm | Tm | | | |
|---|---|---|---|---|---|---|---|
| No. | (J/g) | (° C.) | (J/g) | (° C.) | 1 mm | 1.5 mm | 3 mm |
| 1 | 103.7 | 111.59 | 100.4 | 153.34 | 65.74 | 78.40 | 97.58 |
| 2 | 103.8 | 122.94 | 101.5 | 156.65 | 25.28 | 37.42 | 80.30 |
| 3 | 103.2 | 125.71 | 103.1 | 157.21 | 23.00 | 42.84 | 64.44 |
| 4 | 110.1 | 126.7 | 105.5 | 157.21 | 15.62 | 29.36 | 56.58 |
| 5 | 100.2 | 125.07 | 98.35 | 157.2 | 21.72 | 39.50 | 63.60 |
| 6 | 92.58 | 114.42 | 88.31 | 150.93 | 54.76 | 66.74 | 96.86 |
| 7 | 99.31 | 120.14 | 97.85 | 152.69 | 23.08 | 33.76 | 74.98 |
| 8 | 100.7 | 122.86 | 100.3 | 153.39 | 22.66 | 40.72 | 60.30 |
| 9 | 101.1 | 124.26 | 96.27 | 153.31 | 6.19 | 10.04 | 35.28 |
| 10 | 84.95 | 111.56 | 93.85 | 147.17 | 56.28 | 67.72 | 96.68 |
| 11 | 93.67 | 117.21 | 93.14 | 149.2 | 21.8 | 31.26 | 71.26 |
| 12 | 96.79 | 120.88 | 93.91 | 150.09 | 14.42 | 26.88 | 47.06 |
| 13 | 96.91 | 121.44 | 94.6 | 150.04 | 6.12 | 9.72 | 31.44 |
| 14 | 90.3 | 108.39 | 91.14 | 143.85 | 59.28 | 70.46 | 96.38 |
| 15 | 91.94 | 114.08 | 90.57 | 145.77 | 23.4 | 33.1 | 74.14 |
| 16 | 92.26 | 118.37 | 87.47 | 147.31 | 15.18 | 25.9 | 47.32 |
| 17 | 94.09 | 118.96 | 98.15 | 147.21 | 6.24 | 9.94 | 31.48 |

### Example Set No. 2

Propylene-butene random copolymner samples were produced and their properties tested in accordance with the procedures outlined above. The properties and experimental results are outlined in the tables below.

The propylene-butene random copolymers were produced with a stereospecific 6^{th} generation Ziegler-Natta magnesium supported/titanium-based catalyst. The catalyst contained a non-phthalate internal donor producing polymers having a broader molecular weight distribution than polymers made using a metallocene catalyst. The process used to produce the polymers is described in the art as the UNIPOL gas phase process. The catalyst used to produce the polymers included a substituted phenylene aromatic diester internal electron donor. The catalyst used is commercially available from W.R. Grace and Company and sold under the trade name CONSISTA. All copolymers were made using an external electron donor and triethylaluminum as a cocatalyst.

Propylene-ethylene random copolymers were also produced. In the table below, for instance, Sample Nos. 20-28, and 32-36 are directed to propylene-butene random copolymers while Sample Nos. 18, 19, 29-31, and 37-40 are directed to propylene-ethylene random copolymers. Sample Nos. 18, 19, 37, and 38 were made with the same catalyst that was used to produce the propylene-butene copolymers. Sample Nos. 29-31, 39, and 40 were made using a phthalate-based catalyst. Some of the polymers produced were combined with either 2000 ppm or 4000 ppm of a nucleating agent, namely TBPMN, while Sample Nos. 20, 23, 26, 29, and 32 did not contain a nucleating agent. The polymer compositions where then injection molded into containers or blow molded into bottles. The following results were obtained.

| | | [symbol] | | [symbol] | [symbol] | [symbol] | Test | | | | | |
|---|---|---|---|---|---|---|---|---|---|---|---|---|
| | | Tested | [symbol] | [symbol] | [symbol] | [symbol] | [symbol] | [symbol] | [symbol] | [symbol] | [symbol] | [symbol] |
| Sample | [symbol] | Application | [symbol] | [symbol] | [symbol] | [symbol] | [symbol] | dg/min | [symbol] | [symbol] | [symbol] | % |
| 18 | [symbol] | Injection [symbol] | [symbol] | [symbol] | [symbol] | [symbol] | [symbol] | [symbol] | [symbol] | [symbol] | [symbol] | [symbol] |
| 19 | [symbol] | Injection [symbol] | [symbol] | [symbol] | [symbol] | [symbol] | [symbol] | [symbol] | [symbol] | [symbol] | [symbol] | [symbol] |
| 20 | [symbol] | Injection [symbol] | [symbol] | [symbol] | [symbol] | 0 | [symbol] | [symbol] | [symbol] | [symbol] | [symbol] | [symbol] |
| 21 | [symbol] | Injection [symbol] | [symbol] | [symbol] | [symbol] | [symbol] | [symbol] | [symbol] | [symbol] | [symbol] | [symbol] | [symbol] |
| 22 | [symbol] | Injection [symbol] | [symbol] | [symbol] | [symbol] | [symbol] | [symbol] | [symbol] | [symbol] | [symbol] | [symbol] | [symbol] |
| 23 | [symbol] | Injection [symbol] | [symbol] | [symbol] | [symbol] | 0 | [symbol] | [symbol] | [symbol] | [symbol] | [symbol] | [symbol] |
| 24 | [symbol] | Injection [symbol] | [symbol] | [symbol] | [symbol] | [symbol] | [symbol] | [symbol] | [symbol] | [symbol] | [symbol] | [symbol] |
| 25 | [symbol] | Injection [symbol] | [symbol] | [symbol] | [symbol] | [symbol] | [symbol] | [symbol] | [symbol] | [symbol] | [symbol] | [symbol] |
| 26 | [symbol] | Injection [symbol] | [symbol] | [symbol] | [symbol] | 0 | [symbol] | [symbol] | [symbol] | [symbol] | [symbol] | [symbol] |
| 27 | [symbol] | Injection [symbol] | [symbol] | [symbol] | [symbol] | [symbol] | [symbol] | [symbol] | [symbol] | [symbol] | [symbol] | [symbol] |
| 28 | [symbol] | Injection [symbol] | [symbol] | [symbol] | [symbol] | [symbol] | [symbol] | [symbol] | [symbol] | [symbol] | [symbol] | [symbol] |
| 29 | [symbol] | Injection [symbol] | [symbol] | [symbol] | [symbol] | 0 | [symbol] | [symbol] | [symbol] | [symbol] | [symbol] | [symbol] |
| 30 | [symbol] | Injection [symbol] | [symbol] | [symbol] | [symbol] | [symbol] | [symbol] | [symbol] | [symbol] | [symbol] | [symbol] | [symbol] |
| 31 | [symbol] | Injection [symbol] | [symbol] | [symbol] | [symbol] | [symbol] | [symbol] | [symbol] | [symbol] | [symbol] | [symbol] | [symbol] |
| 32 | [symbol] | Injection [symbol] | [symbol] | [symbol] | [symbol] | 0 | [symbol] | [symbol] | [symbol] | [symbol] | [symbol] | [symbol] |
| 33 | [symbol] | Injection [symbol] | [symbol] | [symbol] | [symbol] | [symbol] | [symbol] | [symbol] | [symbol] | [symbol] | [symbol] | [symbol] |
| 34 | [symbol] | Injection [symbol] | [symbol] | [symbol] | [symbol] | [symbol] | [symbol] | [symbol] | [symbol] | [symbol] | [symbol] | [symbol] |
| 35 | [symbol] | [symbol] | unknown | unknown | unknown | [symbol] | [symbol] | [symbol] | [symbol] | [symbol] | [symbol] | [symbol] |
| 36 | [symbol] | [symbol] | unknown | unknown | unknown | [symbol] | [symbol] | [symbol] | [symbol] | [symbol] | [symbol] | [symbol] |
| 37 | [symbol] | [symbol] | unknown | unknown | unknown | [symbol] | [symbol] | [symbol] | [symbol] | [symbol] | [symbol] | [symbol] |
| 38 | [symbol] | [symbol] | unknown | unknown | unknown | [symbol] | [symbol] | [symbol] | [symbol] | [symbol] | [symbol] | [symbol] |
| 39 | [symbol] | [symbol] | unknown | unknown | unknown | [symbol] | [symbol] | [symbol] | [symbol] | [symbol] | [symbol] | [symbol] |
| 40 | [symbol] | [symbol] | unknown | unknown | unknown | [symbol] | [symbol] | [symbol] | [symbol] | [symbol] | [symbol] | [symbol] |

| | Haze | | | Clarity | | | Glass | | [symbol] | [symbol] | [symbol] | [symbol] | [symbol] |
|---|---|---|---|---|---|---|---|---|---|---|---|---|---|
| Sample | [symbol] | [symbol] | [symbol] | [symbol] | [symbol] | [symbol] | [symbol] | [symbol] | [symbol] | [symbol] | ° C. | ° C. | ° C. |
| 18 | [symbol] | [symbol] | [symbol] | [symbol] | [symbol] | [symbol] | [symbol] | [symbol] | [symbol] | | [symbol] | [symbol] | [symbol] |
| 19 | [symbol] | [symbol] | [symbol] | [symbol] | [symbol] | [symbol] | [symbol] | [symbol] | [symbol] | | [symbol] | [symbol] | [symbol] |
| 20 | [symbol] | [symbol] | [symbol] | [symbol] | [symbol] | [symbol] | [symbol] | [symbol] | | [symbol] | [symbol] | [symbol] | [symbol] |
| 21 | [symbol] | [symbol] | [symbol] | [symbol] | [symbol] | [symbol] | [symbol] | [symbol] | | [symbol] | [symbol] | [symbol] | [symbol] |
| 22 | [symbol] | [symbol] | [symbol] | [symbol] | [symbol] | [symbol] | [symbol] | [symbol] | | [symbol] | [symbol] | [symbol] | [symbol] |
| 23 | [symbol] | [symbol] | [symbol] | [symbol] | [symbol] | [symbol] | [symbol] | [symbol] | | [symbol] | [symbol] | [symbol] | [symbol] |
| 24 | [symbol] | [symbol] | [symbol] | [symbol] | [symbol] | [symbol] | [symbol] | [symbol] | | [symbol] | [symbol] | [symbol] | [symbol] |
| 25 | [symbol] | [symbol] | [symbol] | [symbol] | [symbol] | [symbol] | [symbol] | [symbol] | | [symbol] | [symbol] | [symbol] | [symbol] |
| 26 | [symbol] | [symbol] | [symbol] | [symbol] | [symbol] | [symbol] | [symbol] | [symbol] | | [symbol] | [symbol] | [symbol] | [symbol] |
| 27 | [symbol] | [symbol] | [symbol] | [symbol] | [symbol] | [symbol] | [symbol] | [symbol] | | [symbol] | [symbol] | [symbol] | [symbol] |
| 28 | [symbol] | [symbol] | [symbol] | [symbol] | [symbol] | [symbol] | [symbol] | [symbol] | | [symbol] | [symbol] | [symbol] | [symbol] |
| 29 | [symbol] | [symbol] | [symbol] | [symbol] | [symbol] | [symbol] | [symbol] | [symbol] | [symbol] | | [symbol] | [symbol] | [symbol] |
| 30 | [symbol] | [symbol] | [symbol] | [symbol] | [symbol] | [symbol] | [symbol] | [symbol] | [symbol] | | [symbol] | [symbol] | [symbol] |
| 31 | [symbol] | [symbol] | [symbol] | [symbol] | [symbol] | [symbol] | [symbol] | [symbol] | [symbol] | | [symbol] | [symbol] | [symbol] |
| 32 | [symbol] | [symbol] | [symbol] | [symbol] | [symbol] | [symbol] | [symbol] | [symbol] | | [symbol] | [symbol] | [symbol] | [symbol] |
| 33 | [symbol] | [symbol] | [symbol] | [symbol] | [symbol] | [symbol] | [symbol] | [symbol] | | [symbol] | [symbol] | [symbol] | [symbol] |
| 34 | [symbol] | [symbol] | [symbol] | [symbol] | [symbol] | [symbol] | [symbol] | [symbol] | | [symbol] | [symbol] | [symbol] | [symbol] |
| 35 | [symbol] | [symbol] | [symbol] | [symbol] | [symbol] | [symbol] | [symbol] | [symbol] | | [symbol] | [symbol] | [symbol] | [symbol] |
| 36 | [symbol] | [symbol] | [symbol] | [symbol] | [symbol] | [symbol] | [symbol] | [symbol] | | [symbol] | [symbol] | [symbol] | [symbol] |
| 37 | [symbol] | [symbol] | [symbol] | [symbol] | [symbol] | [symbol] | [symbol] | [symbol] | [symbol] | | [symbol] | [symbol] | [symbol] |
| 38 | [symbol] | [symbol] | [symbol] | [symbol] | [symbol] | [symbol] | [symbol] | [symbol] | [symbol] | | [symbol] | [symbol] | [symbol] |
| 39 | [symbol] | [symbol] | [symbol] | [symbol] | [symbol] | [symbol] | [symbol] | [symbol] | [symbol] | | [symbol] | [symbol] | [symbol] |
| 40 | [symbol] | [symbol] | [symbol] | [symbol] | [symbol] | [symbol] | [symbol] | [symbol] | [symbol] | | [symbol] | [symbol] | [symbol] |

[symbol]

indicates data missing or illegible when filed

Sample Nos. 19 and 22 above were also tested for haze on the injection molded article after one year of production and compared to a commercial grade propylene-ethylene random copolymer having the following characteristics.

| Sample | MFR | XS | Et % |
|---|---|---|---|
| No. | (g/10 min) | (wt %) | (wt %) |
| 41 | 50 | 6.3 | 3.7 |

The following results were obtained:

| | Haze % (1 year | Aged haze % | Aged haze change % |
|---|---|---|---|
| Sample | later) | (55 C., 24 h) | after 1 year |
| 19 | 3.8 | 4.9 | 33% |
| 22 | 4.2 | 4.6 | 10% |
| 41 | 7.9 | 11.8 | 94% |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A polymer composition comprising:
a propylene-butene copolymer comprising propylene as a primary monomer,
the propylene-butene copolymer containing butene in an amount from about 1% to about 12% by weight,
the polymer having a xylene soluble fraction of from about 1.0% to about 8.0% by weight,
the propylene-butene copolymer having a molecular weight distribution (Mw/Mn) of greater than about 3.5;
a nucleating agent; and
wherein the polymer composition displays a haze at 1 mm of less than about 25% and wherein after thermal aging for 24 hours at 55° C., the haze increases by no more than about 30%.

2. The polymer composition of claim 1, wherein the polymer composition displays a haze at 1 mm of less than about 20%.

3. The polymer composition of claim 1, wherein after thermal aging for 24 hours at 55° C., the haze of the polymer composition increases by no more than about 25%.

4. The polymer composition of claim 1, wherein after thermal aging for 24 hours at 55° C., the haze of the polymer composition increases by no more than about 10%.

5. The polymer composition of claim 1, wherein the polymer has a xylene soluble fraction/butene content ratio of from about 0.3 to about 3.0.

6. The polymer composition of claim 1 4, wherein the nucleating agent comprises a nonitol.

7. The polymer composition of claim 1, wherein the polymer composition has a melt flow rate of from about 0.25 g/10 min to about 225 g/10 min.

8. The polymer composition of claim 1, wherein the polymer composition has a melt flow rate of from about 1 g/10 min to about 60 g/10 min.

9. The polymer composition of claim 1, wherein the polymer composition displays a flexural modulus of greater than about 1000 MPa, such as greater than about 1200 MPa.

10. The polymer composition of claim 1, wherein the propylene-butene copolymer is catalyzed in the presence of a non-phthalate based Ziegler-Natta catalyst.

11. (canceled)

12. The polymer composition of claim 1, wherein the propylene-butene copolymer is present in the polymer composition in an amount greater than about 70% by weight.

13. The polymer composition of claim 1, wherein the propylene-butene copolymer contains butene in an amount from about 2% to about 8% by weight.

14. The polymer composition of claim 13, wherein the propylene-butene copolymer displays a heat distortion temperature of greater than about 75° C., and a melting point of from about 143° C. to about 155° C.

15. (canceled)

16. The polymer composition of claim 1, wherein the propylene-butene copolymer has a xylene soluble content of from about 2% to about 6% by weight.

17. The polymer composition of claim 1 further comprising at least one antioxidant and at least on acid scavenger.

18. An injection molded article made from the polymer composition gf claim 1.

19. A blow molded article made from the polymer composition of claim 1.

20. A thermoformed article made from the polymer composition of claim 1.

21. The blow molded article of claim 18, wherein the polymer composition has a melt flow rate of less than about 4 g/10 min.

22. A container, or a food packing, or a medical device made from the polymer composition of claim 1.

23-25. (canceled)
